(19) United States
(12) Patent Application Publication
(10) Pub. No.: US 2009/0111941 A1
(43) Pub. Date: Apr. 30, 2009

(54) EXTRUDABLE AND CROSS-LINKABLE SLIP COATS

(75) Inventors: Henry Kim, Canton, MI (US); Liggett Cothran, Lambertville, MI (US)

Correspondence Address: Fay Sharpe LLP, 1228 Euclid Avenue, 5th Floor, The Halle Building, Cleveland, OH, 44115, US

(73) Assignee: Cooper-Standard Automotive Inc.

(21) Appl. No.: 11/931,572

(22) Filed: Oct. 31, 2007

(51) Int. Cl. C08L 23/06

(52) U.S. Cl. 525/70

(57) ABSTRACT

A cross-linked, extruded article comprising an elastomeric base material, the surface of which is applied with a thermoset slip coat material, the article exhibiting enhanced slip and a coefficient of friction of no greater than 0.25 and process of making is provided. An extrudable, cross-linkable slip coat comprising a cross-linked thermoset polymer capable of bonding with an elastomeric base material in the absence of adhesive or binder upon contact and process of making is also provided.

### BACKGROUND OF THE INVENTION

The present disclosure relates to extrudable and cross-linkable slip coat compositions. It finds particular application in those instances where a layer of material having low friction and good abrasion resistance is advantageous, for example in the automotive industry, particularly in glass run channels. However, it is to be appreciated that the present invention will have wide application in many fields where extrudable coatings are used.

Extrusion, as used herein, refers to the production or manufacture of a material by adding the material to a chamber or hopper. The material, which may have several components, may be premixed or may be mixed upon addition to the extruder. The extruder, generally, includes a motorized screw that turns to draw the material through the extruder usually with the application of heat, causing the material to become molten. The material, in this molten or viscous state, is then forced through the head of a die, producing a tube-like shape of material. The material may be left in long ribbons, which may be wound for instance on a reel, or may be chopped or otherwise portioned into pieces meeting specific physical parameters. The die head may be configured to produce a particular shape, such as an L-shape or a T-shape, or even a more intricate shape, depending on the use for which the extruded material is intended. During the extrusion process the material can undergo physical and chemical changes, such that the extruded material exhibits certain desirable characteristics. For example, it has been known to extrude ribbons or sheets of polymeric material which can be later subjected to cross-linking or other processing to improve still further the properties of the material extruded.

It is known in the automotive industry to use molding or extrusion processing to produce certain rubber-based components, such as weather seals, edge seals, and the like. In addition to the foregoing, and of particular interest, is the use of extrusion processing to produce glass run channels. Polymer materials used for this type of application desirably exhibit good abrasion resistance and have a low coefficient of friction. For example, weather stripping and glass run channels have been manufactured using a hard resin base material having laminated thereto another synthetic resin material or a combination of materials. The base material provides a solid support having good abrasion resistance. This material, however, may exhibit a higher coefficient of friction than is desired for applications where constant friction is experienced, such as for use in glass run channels. Therefore, it has been known to add a laminated layer, or an adhesively bound layer to provide good friction properties, or slip. One such material commonly used in the automotive industry as a slip layer is referred to as flocking. Flocking generally comprises a fiber nap material, such as nylon. The nylon fibers are “flocked” or implanted on the surface of the base material where the material contacts the window to provide for a smooth transfer of the window glass against the hard polymer edge material. Alternatively, the nylon fibers may be provided in the form of a flocked tape which is adhesively bound to the surface of the polymer edge material. However, flocking suffers from degradation due to the repeated raising and lowering of the window and wears out, requiring replacement. In addition, known and commonly employed methods for adhering the flocking to the rubber base often require the use of volatile organic compounds, VOC's, which cause environmental concerns.

This problem has been addressed by certain polymeric composite materials. For example, U.S. Pat. No. 5,343,655, U.S. Pat. No. 5,441,685, and U.S. Pat. No. 5,424,019 all seek to provide an alternative. These patents teach the use of thermoplastic composites in place of the flocking. Thermoplastic materials are characterized by the ability of the material to be repeatedly softened or melted by increases in temperature followed by subsequent solidification on cooling. When softened, the material can be shaped and reshaped. These materials, while they represent some level of improvement, nonetheless suffer from certain drawbacks particular to thermoplastic compounds.

Therefore, there remains a need in the automotive industry for an economical means to apply a pliable slip coat to the a base resin coat without the need to use adhesives or undesirable organic compounds, the slip coat exhibiting good abrasion resistance and at the same time having a low coefficient of friction. Further, there remains a need for a material meeting these parameters which can be manufactured simultaneously with the base resin.

### BRIEF SUMMARY OF THE INVENTION

In a first embodiment, there is provided a cross-linked, extruded article comprising an elastomeric base material, the surface of which is applied with a thermoset slip coat material, the article exhibiting enhanced slip and a coefficient of friction of no greater than 0.25.

In a second embodiment, there is provided an extrudable, cross-linkable slip coat comprising a cross-linked thermoset polymer capable of bonding with an elastomeric base material in the absence of adhesive or binder upon contact.

In a third embodiment, there is provided a process for producing an abrasion resistant rubber strip material, the process comprising mixing a polyolefin with a graft polyethylene to produce a thermoset polymer slip coat mixture; extruding an at least partially cured elastomeric polymer base material; contacting the thermoset polymer slip coat material with the elastomeric polymer base material; bonding the elastomeric base material surface and the thermoset polymer slip coat material surface at the point of contact and in the absence of binder or adhesive; and cooling the rubber strip material.

### BRIEF DESCRIPTION OF THE DRAWINGS

FIG. 1 is a diagram of an extruded of the type used in an embodiment of this invention.

FIG. 2 a flowchart depicting the main processing steps in the manufacture of the extrudable, cross linkable slip coat and base material according to the invention.

### DETAILED DESCRIPTION OF THE INVENTION

The present invention provides a variety of sealing strips, weather strips, glass run channels, and similar products for use in automotive vehicles. For ease of description, the following is described with reference to use of the material as a slip coat for the rubber moldings in a glass run channel in an automobile or other vehicle. The invention is not limited to use for this purpose, however, and is equally applicable to other uses in the automotive industry and in other industries where the properties exhibited by the material prove beneficial.

Now then, in one embodiment, the extrudable slip coat finds application as mentioned above for glass run channels of automobiles and other vehicles. The extrudable slip coat is applied in combination with a resin base coat of the type disclosed in US Pub. App. 2005/0095374, to our common assignee, the disclosure of which is incorporated herein by reference. As taught therein, the base member or resin may be any conventional material generally used for such purposes, including elastomeric rubbers, thermoplastic vulcanizates and other elastomeric polymers. The elastomer of the base resin may include various additives, such as vulcanization agents, colorants, lubricants, plasticizers, fillers, slip agents, processing oils, and antioxidants. These additives are added prior to formation of the base resin into the desired shape or configuration, and are added in amounts that will not adversely affect the performance of the base resin.

Applied to the elastomeric base resin is an extrudable and cross-linkable slip coat. This slip coat is applied at the surface of the base coat that will, in the instance where it is used for a glass run channel, contact the glass window of the vehicle, or where it is necessary to provide abrasion resistance and slip. It is desirable to provide the slip coat in a manner that avoids the need to use adhesives or other laminating techniques. Alternatives to the current slip coat include the use of known plastic materials. The slip coat material according to the invention, however, has several advantages over known plastic materials. For example, with regard to a commonly used plastic, such as that commercially available from Tokiwha, sold as Lubner TM-80B, the slip coat herein exhibits improved hardness and elongation. Due to the improved hardness, the slip coat demonstrates a lower co-efficient of friction, and better abrasion resistance. The improved elongation of the slip coat provides for enhanced flexibility, which allows the slip coat to be worked into necessary shapes or configurations, for example by bending, without suffering spalling or delamination as is typical with known plastics. For example, the subject slip coat has an elongation parameter of at least about 300%, while TM-80B exhibits only about 45% elongation. In addition to the foregoing, the slip coat is less expensive to manufacture, thereby reducing processing costs. Table 1 sets forth physical parameters of three samples of the graft polyethylene component of the slip coat according to the invention, as compared to those of the known and commercially available alternative plastic slip coat, TM-80B. It is understood that the addition of the polyolefin component, which is used to enhance hardness of the slip coat, and therefore abrasion resistance, may slightly affect the properties of the slip coat as compared to those set forth in Table 1 for the graft polyethylene. The use of the polyolefin is easily controlled, however, so that any variations are insignificant with regard to the desired over-all slip coat performance.

TABLE 1

| | Hardness | Tensile Strength | Elongation | |
|---|---|---|---|---|
| Samples | Shore D | (MPa) | (%) | COF |
| S-1¹ | 50 | 11.7 | 525 | 0.22 |
| S-2² | 50 | 11.8 | 367 | 0.20 |
| S-3³ | 65 | 27.6 | 41 | 0.11 |
| TM-80B | 64 | 33.7 | 45 | 0.15 |

¹S-1 is S1054A PolyOne low to medium density graft polyethylene
²S-2 is AQ120-000 Equistar medium density graft polyethylene
³S-3 is S1016A PolyOne high density graft polyethylene

The data in Table 1 shows that the graft polyethylene products tested exhibit a comparable coefficient of friction to the plastic generally used, as well as comparable hardness. However, the low to medium density graft polyethylenes demonstrate greatly improved elongation, 525% and 367% as compared to 45%. This combination, therefore, provides a slip coat with desirably enhanced properties.

In addition to the foregoing, the slip coat according to the invention exhibits increased flexibility as compared to known thermoplastic materials, thus providing a smoother, more continuous fit for improved performance as well as improved appearance, and exhibits a flex modulus of about 180,000.

Yet another advantage of the slip coat herein is that it may be used with rubber base materials, unlike know slip coat alternatives that are suited only for use with plastic base materials.

One reason for the foregoing is that the slip coat of this invention is characterized as a thermoset, as opposed to known thermoplastic slip coat layers, such as the TM-80 referred to earlier. A thermoset material is commonly characterized as a material that, once cured and hardened by heat or other means, is substantially infusible and insoluble. Thermoset materials commonly exhibit some degree of cross-linking, which imparts infusible and insoluble characteristics to the thermoset.

In addition, the slip coat according to the disclosure, is self-adhering with regard to a rubber-type base layer. By this it is meant that the slip coat does not require the application of an adhesive in order to be attached to the base layer. Instead, the slip coat, as it is extruded simultaneously with the rubber base material, bonds to the surface of the base material due to the temperature at which the base and slip coat are extended, which is generally high enough to soften both materials enough to cause them to bond upon contact and subsequent cooling.

The slip coat provided herein depending on the over-all composition as described hereafter, exhibits a coefficient of friction of about 0.1 to 0.25. This is similar to that of TM-80B which demonstrates a coefficient of friction of about 0.15, and is considerably lower than the flocking generally used, which exhibits a coefficient of friction of 0.5 to 0.8. This parameter measures the ease with which contacting materials slide over one another, or the amount of friction provided by one material when in contact with another material. Therefore, it is desirable that the coefficient of friction of a material for use in glass run channels, where the window glass will continually be run up and down against the slip coat, be as low as possible without sacrificing other necessary performance parameters.

Turning now to the slip coat composition, the slip coat includes a plastic, polyolefin, polyethylene or polypropylene, which may be a medium to high density polyolefin. This polyolefin component is employed in combination with a grafted polyethylene component. In addition, the slip coat may contain a pigment or other appropriate colorant, and other optional additives to address lubrication, wear, and friction properties, among others.

In one embodiment, the polyolefin is a medium to high density polyethylene. While a lower density polyethylene may be used if desired, generally, low density polyethylene does not satisfy the hardness requirements necessary for use in automotive applications of the type discussed herein. In fact, medium density polyethylene may not exhibit the requisite physical parameters. Preferably, the polyethylene is a high density polyethylene. For example, suitable high density polyethylene may be purchased commercially from Equistar under the tradename Alathon® 9305 TC or Alathon® M6028. Equistar is also a provider of medium density polyethylene, under the tradename Alathon® M6020, and low density polyethylene, under the tradename GA502 or GA503. As is noted above, the hardness of the lafter materials may be unacceptable for use in the automotive applications contemplated for the slip coat described herein. The polyolefin component may be included as up to about 60% of the total slip coat, based on the total weight of the formulation.

The grafted polyethylene component is a polyethylene grafted with a vinyl silane. Grafted polyethylenes exhibit good abrasion resistance, and higher temperature performance. This is due in part to the fact that the grafted polyethylene, in the presence of heat and moisture, undergoes a cross-linking reaction. It is generally desirable to allow this reaction to progress over a period of from several hours up to 1 or 2 days. Grafted polyethylenes suited for use herein are generally stable and exhibit a long shelf life, of anywhere from 30 days to up to 2 years. The grafted polyethylene is included as at least about 30% of the slip coat formulation, and preferably constitutes from 40% to 100% of the slip coat. While it would be possible to use the grafted polyethylene alone, a product made in this manner would not be likely to exhibit the requisite hardness and abrasion resistance for purposes such as the glass run channel. The polyolefin component enhances these properties. Suitable grafted polyethylene products that are available commercially include S1054A and S1016A from PolyOne, and AQ120-000 from Equistar, and 2200 from Noveon, for example. Other similar grafted polyethylene products may also be used.

In practice, the slip coat formulation may further include colored pigment. While any color pigment may be added to the formulation, black is generally used for the automotive industry given the desire to have the material blend in with the vehicle. The pigment is added in an amount suitable to provide solid coloring without adversely affecting the performance of the slip coat in any manner.

Other additives may include Teflon powder, which is added to further enhance the slip properties of the formulation and to increase the wear resistance. This can be important depending on the placement of the slip coat, which in one embodiment is in direct contact, in a glass run channel for instance, with the window glass of the vehicle as the window is continuously raised and lowered. As may be anticipated, the constant rub of the glass on the slip coat may cause wear and degradation in a material which is not wear or abrasion resistant. Another additive which may be included in the slip coat formulation according to the invention is molybdenum disulfide, which functions to further reduce the coefficient of friction of the material. Therefore, a combination of these materials can prove even more advantageous than either additive alone, though the use of one or the other, or any similar materials, is acceptable. Suitable additives, including the foregoing and others, are known to those skilled in the art. In those instances where it is necessary to perform quality checks on materials, for instance to determine where material has and has not been deposited, the material may include a UV tracer, detectable by UV light. In this manner, the exact location of the material can be detected by exposing the piece to a UV light source.

In practice, the slip coat may be prepared in advance of its combination with the polymer resin base or may be prepared as it is combined with the base polymer. In the former instance, the polyethylene components and any additives may be combined in keeping with known mixing techniques. The resulting polymeric material may be pelletized, chopped, or otherwise prepared for ease of addition to an extruder at a subsequent time.

The formulation may further include a cross-link accelerator, though such is not necessary. If in fact, however, the accelerator is to be used, it is not added at the time of initial mixing of the slip coat formulation, as this may cause the formulation to cross-link prematurely, prior to extrusion in the presence of the base polymeric material

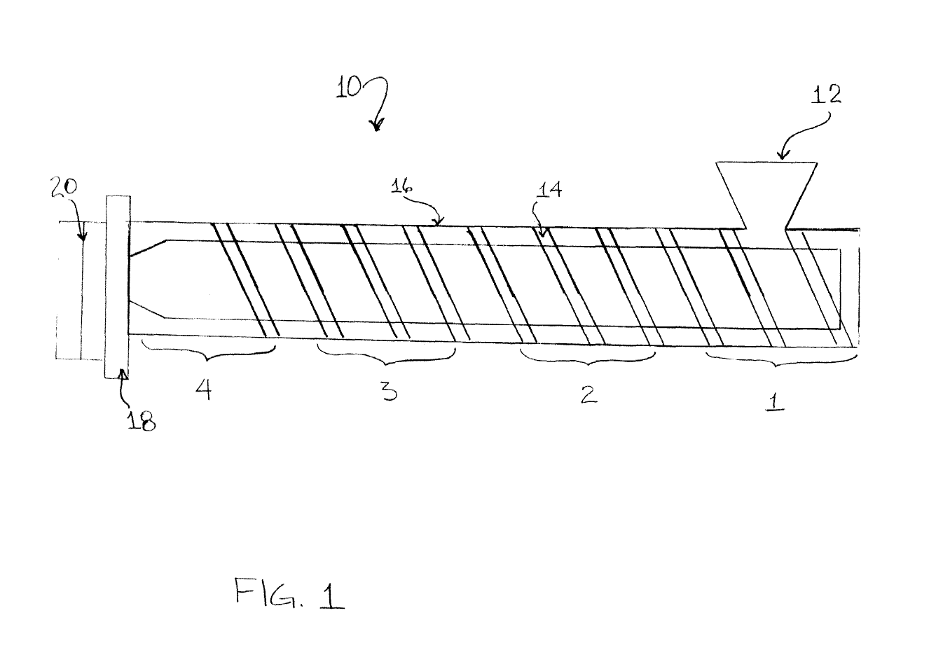

Alternatively, the various components of the formulation may be mixed just prior to addition to the extruder. In this instance, and with reference to FIG. 1, a diagram is provided with regard to an extruder which may be used in preparing the slip coat for a part for a glass run channel according to the invention. At one end of extruder 10 is hopper 12. The components of the slip coat, including a polyolefin, a grafted polyethylene and optional additives such as pigment or other colorant, heat stabilizers, accelerators, and the like, are added to hopper 12. This may be done prior to any mixing of the slip coat components, or the components may be pre-mixed and this pre-mix added to hopper 12. The slip components, or the pre-mix, whichever is used, exits hopper 12 and falls onto the flights 14 of the extruder screw. This occurs in what is designated at number 1 in FIG. 1, corresponding to heat zone 1, which operates at a temperature of about 340° F. As the extruder screw rotates, the flights 14 convey the slip coat material along the length of extruder barrel 16. The extruder shown in FIG. 1 has four (4) heat zones along the length of the barrel, though more or fewer heat zones may be used without departing from the invention. Each successive heat zone, i.e., heat zone 3, 3 and 4, designated by like numbers in FIG. 1, correspond to an increase in temperature of the extruder barrel 16. Heat bands, not shown, are used to heat the barrel in each zone. Therefore, heat zone 1 may be at about 340° F., heat zone 2 at 360° F., heat zone 3 at 380°, and heat zone 4 at 400° F. These temperatures are merely exemplary and not intended as exact heat parameters. Any heat regimen may be used that results in homogeneous mixing of the slip coat components, producing a soft, pliable material at the gate area 18 of the extruder 10. As the slip coat material is conveyed through each zone its temperature increases and pressure builds, helping to mix the slip coat components. The mixed slip coat material is soft and pliable as it enters gate adapted area 18, which is at about 400° F., and is then fed into die area 20, also at about 400° F. Die are 20 shapes the material into the final profile for the part being produced. Though not shown, a second extruder may simultaneously extrude the base material, such that the base material and slip coat material exit the die area to come in bonding contact with one another.

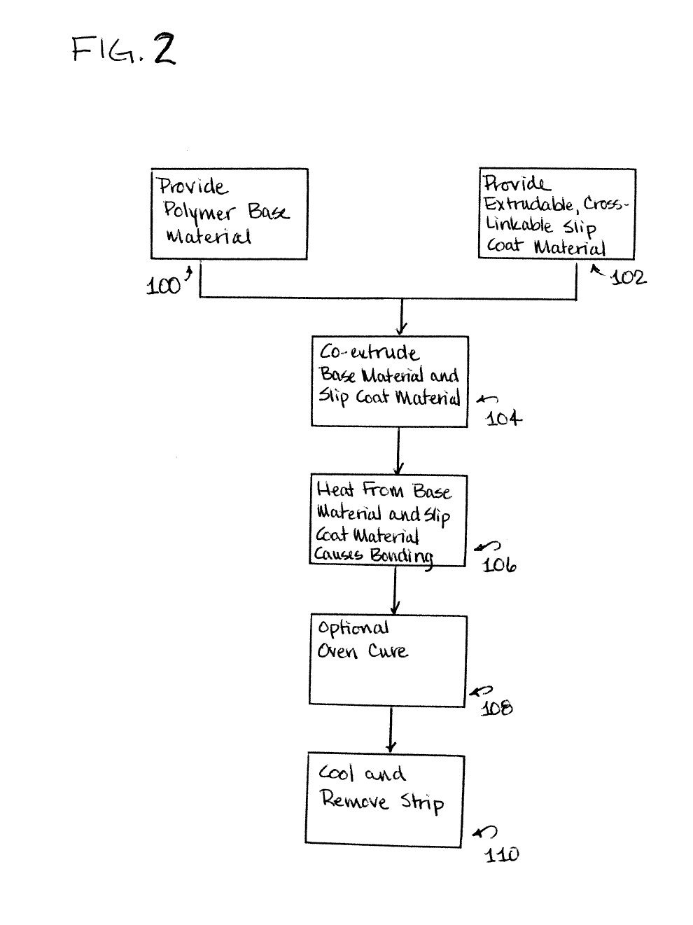

Now then with reference to FIG. 2, a flow diagram is provided. While this chart contemplates a glass run channel, it will be understood that the process is equally applicable to the preparation of other parts and products. The individual components of the slip coat are mixed under heat and pressure in extruder 102 (which corresponds to that shown in FIG. 1) to produce the soft, pliable slip coat.

As is noted above, as the slip coat components move through the extruder, they are mixed by the turning action of the screw. In addition, the heat of the extruder barrel and the speed at which the material moves through the extruder barrel cause pressure to build in the barrel melting or softening the material, and aiding in the mixing of the components, resulting in a slip coat material of the desired thickness and viscosity which can be combined with the base material.

The slip coat exits from extruder 102 directly into contact with the TPV or EPDM base material, which is being simultaneously extruded from a second profile extruder 100. As the slip coat and base material streams exit the respective extruders 102/100, they are combined in the appropriate proportion and manner 104, i.e., with the slip coat in a predetermined physical relation to the base coat. Heat from the base material and the slip coat cause the base and slip coat to bond upon contact 106. Optionally, the combined materials may enter an oven 108 at this point in the processing to enhance curing. Alternatively, the combined, base and slip coat proceed to be cooled and then removed 110. Heat and moisture in the extrusion process initiate the cross-linking reaction in the slip coat material. Allowing this reaction to progress slowly, over a period of hours or even days, results in a cross linked strip coat material that has fewer defects.

The materials which are combined to generate the slip coat herein exhibit the unique feature of being catalyzed by the presence of moisture and heat. For this reason, if the slip coat is prepared in advance of combination with the base coat, it must be stored under anhydrous and cool conditions. Atmospheric moisture is enough to initiate the cross-linking reaction in the slip coat material. Further, the presence of heat in addition to any moisture will act as an accelerator and drive the cross-linking reaction at a quicker pace. Therefore, transfer of the extrudate from a die and through an oven may cause the cross-linking reaction to advance more quickly. Because it is desirable in this instance for the slip coat to remain uncross-linked until it comes in contact with the surface of the base rubber material, it is important that pre-mixed slip coat, if not extruded to directly contact the base rubber material, be maintained in a moisture free atmosphere until use. While it is preferable to combine the slip coat with the base material upon mixing, an additional advantage to the current thermoset slip coat is the ease with which the material is handled due to a lack of the tacky or sticky nature of more conventionally used thermoplastics.

The elastomeric or rubber base polymer material generally exits the profile extruder at a temperature of from about 340° F. to about 460° F. The inventive slip coat material, unlike known plastic slip coats used for this purpose, is able to undergo cross-linking during the extrusion process upon contact with the elastomeric, rubber base material, due to the temperature and softened state of the base material. As this occurs, the slip coat polyethylene components bond to the base coat surface. The slip coat exits the die at a temperature of about 430° F., though this temperature is not critical. From this point in the processing, the at least partially cross-linked slip coat bonded to the material passes through a water bath to cool the part to room temperature. The cross-linking reaction of the slip coat is allowed to proceed slowly to completion, for example it may take as long as 7 days and up to 30 days for the slip coat material to be fully cured. The rubber base material, however, is fully cured as it exits the die of the extruder, even though it may still be in a softened state.

The amount of slip coat extruded and combined with the base rubber material to form a given part, for example a glass run channel, is determined predominantly by the cross-sectional parameters, or size, of the base material and the part to be formed. For a glass run channel, for example, the finished part may have as little as 0.01% slip coat by weight of the part, or up to about 10% slip coat by weight of the part or more.

As is noted above, the cross linking process of the slip coat, containing the polyolefin material and grafted polyethylene materials according to the invention, is catalyzed by the presence of moisture, and optionally heat. An accelerator, such as dibutyltin or polyethylene dilaurate, or other know accelerants may be applied. It is sometimes preferable to allow the process to proceed at a slower speed to reduce the number of defects in the resulting material. The speed of the cross-linking reaction is determined by the ambient conditions, wherein the higher the temperature and the more moisture present, the faster the cross-linking progresses. The resulting material exhibits enhanced properties, including but not limited to: good wear resistance, resulting in longer life of the part; low coefficient of friction, also contributing to longevity of the part; lower manufacturing costs; and ease of processing.

Another advantage of the current slip coat is seen in a comparison of the slip coat according to the invention to flocking. Flocked surfaces tend to experience freezing during colder weather. By this is meant that water has a tendency to freeze onto the flocking, thus reducing the efficiency thereof to promote slip. Overtime, the continued exposure of the flocking to freeze and thaw cycles, as well as the trapping of particulate matter, causes the flocking to degrade and to be destroyed, reducing its ability to provide slip, and actually creates drag which inhibits, for example, window movement, putting a greater drain on the power supply. The slip coat herein described, however, is an improvement to flocking in that water does not freeze to the slip coat material, so any ice formed in the area of the glass run channel or other part easily breaks away, leaving the slip coat free of debris. In addition, its smooth surface does not trap and hold particulate matter as readily as the flocking. The foregoing advantages combine to provide yet another advantage when using the slip coat in the automotive industry. Given the increased slip, or reduced coefficient of friction, a lesser power source, for example providing a 25% lower amp draw, can be used within the door of the vehicle, i.e., to power the window, for example. This alone makes the slip coat an attractive alternative to known friction reducing materials.

The invention has been described with reference to use of the inventive slip coat as a molding or strip for a glass run channel. Obviously, modifications and alterations will occur to others upon a reading and understanding of the specification. The invention is intended to include all such modifications and alterations insofar as they come within the scope of the appended claims and the equivalents thereof. Thus, for example, composite extrusions for other industries may be manufactured based on the principles advanced herein.

1. An extrudable, cross-linkable slip coat comprising a cross-linked thermoset polymer capable of bonding with an elastomeric base material in the absence of adhesive or binder upon contact.

2. The extrudable, cross-linkable slip coat of claim 1 wherein the slip coat undergoes further cross-linking upon exposure to moisture and heat.

3. The extrudable, cross-linkable slip coat of claim 2 wherein the addition of heat catalyzes the cross-linking reaction.

4. The extrudable, cross-linkable slip coat of claim 1 wherein the slip coat comprises a polyolefin polymer in combination with a grafted polyethylene polymer.

5. The article of claim 1 further comprising an elastomeric base material, the surface of which has applied thereto a thermoset slip coat material, the article a coefficient of friction of no greater than 0.25.

6. The article of claim 5 wherein the thermoset slip coat material comprises a polyolefin component and a grafted polyethylene component.

7. The article of claim 5, wherein the thermoset slip coat material is co-extruded with the elastomeric base material, and the temperature of the elastomeric base material and the slip coat material causes bonding to initiate between the slip coat and the base material.

8. A process for producing an abrasion resistant rubber strip material, the process comprising:
mixing a polyolefin with a graft polyethylene to produce a thermoset polymer slip coat mixture;
extruding an at least partially cured elastomeric polymer base material;
contacting the thermoset polymer slip coat material with the elastomeric polymer base material;
bonding the elastomeric base material surface and the thermoset polymer slip coat material surface at the point of contact and in the absence of binder or adhesive; and
cooling the rubber strip material.

9. The process of claim 8 wherein the thermoset polymer slip coat comprises up to 60% polyethylene or polypropylener or a mixture thereof and from 40% to 100% grafted polyethylene.

10. The process of claim 9 wherein the grafted polyethylene is a medium to high density grafted polyethylene.

11. The process of claim 8 wherein the elastomeric polymer base material comprises TPO, TPV or EPDM.

12. The process of claim 8 wherein the thermoset polymer slip coat and the elastomeric polymer base material are co-extruded.

13. The process of claim 8 including the additional step of storing the thermoset polymer slip coat mixture under anhydrous, low temperature conditions prior to extruding the elastomeric polymer base material and contacting the thermoset polymer slip coat and the elastomeric polymer base material.

14. The process of claim 8 wherein the thermoset polymer slip coat undergoes a cross-linking reaction initiated by the heat and moisture of the extruder.
